(19) United States
(12) Patent Application Publication
(10) Pub. No.: US 2008/0082658 A1
(43) Pub. Date: Apr. 3, 2008

(54) Spam control systems and methods

(76) Inventors: Wan-Yen Hsu, Cupertino, CA (US); Eric C. Scoredos, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/540,274

(22) Filed: Sep. 29, 2006

(51) Int. Cl. G06F 15/173

(52) U.S. Cl. 709/224

(57) ABSTRACT

Various embodiments of spam control systems and methods are disclosed. One method embodiment, among others, comprises identifying an IP address as a spam source, and monitoring the activity of the IP address to determine if the IP address is re-assigned to another source.

### BACKGROUND

Electronic mail (e-mail) users routinely receive spam, which generally refers to unsolicited and/or unwanted email messages. For instance, spam is often embodied in the form of unsolicited marketing materials that are emailed, often indiscriminately, to a plurality of users. Those who provide spam are often referred to as spammers. Many techniques have been developed in order to mitigate the impact that spam can have upon a user. For example, most Internet service providers (ISPs) offer spam filtering facilities, which work to filter out spam. Typically, these spam filtering facilities rely on a pre-established list or lists of suspected or known spam e-mail sources. Such a list is typically maintained as a list of source addresses, such as Internet protocol (IP) addresses.

An IP address generally refers to a unique number (e.g., often in a format of 32-bits divided into four 8-bit fields, the number of each field ranging from 0-255 resulting in an address such as 15.13.10.20) that a device uses in order to identify and communicate with other devices on a computer network that utilizes the IP standard. When a device, such as a server, is always configured with the same address, it is often said to possess a permanent or static IP address. Hence, when data packets or connection requests (e.g., attempts by devices to provide a connection for email communication according to the transmission control protocol (TCP)) from a particular source IP address arrive at either an e-mail server or an e-mail client, those data packets are simply discarded upon a granted connection and/or the connection requests are ignored (e.g., reset).

In addition, many spam filtering facilities only allow e-mail to be received from a list of recognized and approved or trusted sources (the list often referred to as a whitelist). Analogously to the mechanisms involved with identifying spam e-mail sources, a list of recognized and approved or trusted e-mail sources may also be maintained as a list of source addresses (e.g., IP addresses). Accordingly, this latter form of a spam filtering facility discards any data packets or resets connection requests that arrive from a source that is not listed in a list of recognized e-mail sources.

One challenge to spam filtering facilities derives from the use of dynamic IP addresses. For instance, ISPs may use dynamic allocation to assign addresses from a small pool to a larger number of customers. Dynamic IP addresses are typically, though not necessarily, assigned randomly, and provide a temporary lease that allows such addresses to be reclaimed by other devices after the end of the lease. Dynamic IP address allocation may be used for dial-up access, WiFi, and other temporary connections. When spammers employ dynamic IP addresses, it is not only difficult to identify these dynamic spam sources, but innocent senders that subsequently inherit a dynamic IP address may be wrongly identified as spammers because they are using an IP address that was previously used by a spam e-mail source and identified as such by a spam filtering facility.

### BRIEF DESCRIPTION OF THE DRAWINGS

Many aspects of spam control systems and methods can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an exemplary processing network in which embodiments of spam control systems and methods are implemented.

FIG. 2 is a block diagram of an embodiment of a spam control system as implemented in an email server in the exemplary processing network shown in FIG. 1.

FIG. 3 is a flow diagram that illustrates an embodiment of a spam control method as implemented by the spam control system shown in FIG. 2.

FIG. 4 is a flow diagram that illustrates an embodiment of a spam control method as implemented by the spam control system shown in FIG. 2.

FIG. 5 is a flow diagram that illustrates an embodiment of a spam control method as implemented by the spam control system shown in FIG. 2.

### DETAILED DESCRIPTION

Various embodiments of spam control systems and methods are disclosed. Such spam control systems provide mechanisms to monitor Internet protocol (IP) addresses, identified as spam sources (e.g., devices used by spammers), to determine whether they are dynamic IP addresses that have been re-assigned as non-spam sources. That is, a change in status of an IP address from a spam source to a non-spam source may occur through re-assignment of the IP address through dynamic allocation, whereby the assigned IP address previously identified as being associated with a spammer is subsequently “dynamically” re-assigned to a device associated with a non-spammer (e.g., innocent, trusted and/or authorized user). Note that the embodiments disclosed herein also function similarly to detect when an IP address has been re-assigned to a spam source. Embodiments of the spam control systems and methods thus provide for more efficient spam filtering by enabling spam control lists to be kept up-to-date and preventing or mitigating the risk of non-spammers using IP addresses, previously recognized as spam sources, from being blocked by spam filtering facilities.

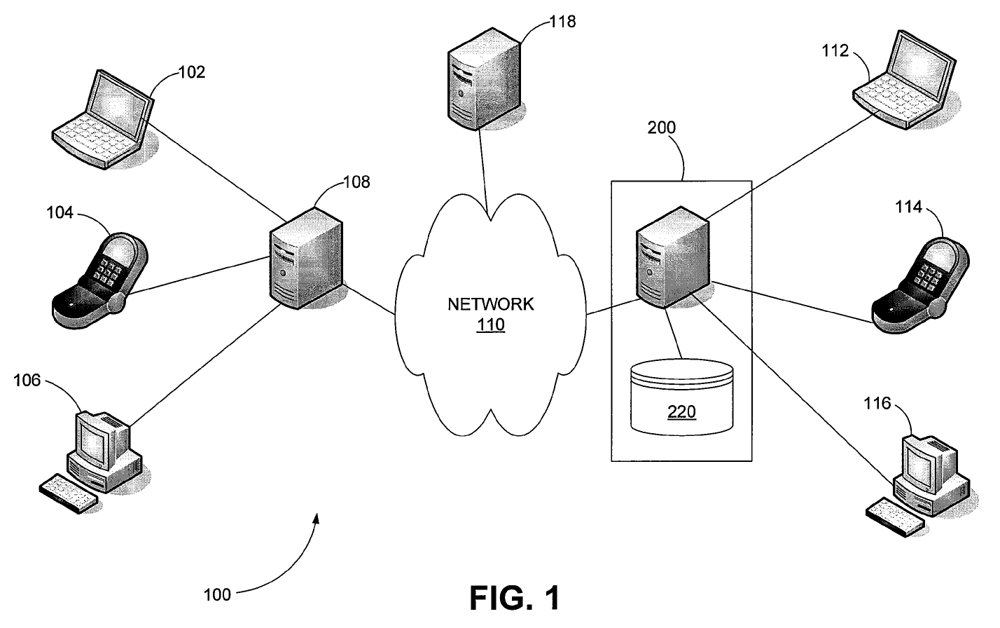

FIG. 1 is a schematic diagram of an exemplary processing network 100 in which embodiments of spam control systems (and methods) 200 are implemented. The processing network 100 may include a plurality of individual networks, such as a wireless network and/or a wired network. The description that follows is based on a convention whereby sending devices send electronic mail (email) through a client server across a network to a spam control system 200 embodied as a recipient mail server, which provides access to email by a recipient device. One skilled in the art would understand that the sending device and client server can function as a recipient device and spam control system (embodied as a recipient server), respectively. In some embodiments, the location of the spam control system 200 may be located elsewhere from that described herein, for instance upstream or downstream of a recipient mail server.

As shown in FIG. 1, the processing network 100 includes a plurality of sending devices 102, 104, and 106 (e.g., wired or wireless devices, such as cellular phones, personal digital assistants (PDAs), computer devices or systems such as laptops, personal computers, etc.,) that are in communication with one or more client servers, such as client server 108. The client server 108 is coupled to a network, such as wide area network (WAN) 110, which in one embodiment comprises the Internet. Other networks are contemplated to be within the scope of the disclosure, including the use of packets incorporated with other transport protocols or standards, as well as other implementations including Denial of Service (DOS) spoofed connection attempts from known client IP addresses. The client server 108 may also comprise, or be in communication with, one or more data repositories (not shown on the client side). Communication between the client server 108 and the sending devices 102-106 may be via wireless or wired connections, including by way of non-limiting example Ethernet, token ring, private or proprietary networks, among others.

One or more of the sending devices 102-106 may serve as a source of spam (i.e., associated with spammers). Client server 108 may comprise a server in an Internet Service Provider (ISP) facility, a private server, an open relay mail server, a dynamic host configuration protocol (DHCP) server, a gateway, and/or other devices or facilities used for email communication. One skilled in the art would understand that other devices, such as routers, bridges, etc., may be employed in the processing network 100. Communication of IP packets between the sending devices 102-106 and the client server 108 and throughout the processing network 100 may be implemented according to one or more of a plurality of different protocols, such as simple mail transport protocol (SMTP), user datagram protocol (UDP)/IP, transmission control protocol (TCP)/IP, among others.

In one implementation, the client server 108 is responsible for the allocation of a range or pool of dynamic IP addresses to be used by one or more of the sending devices 102-106, as well as the assignment of dynamic IP addresses to the sending devices 102-106. Although described in the context of the assignment of dynamic IP addresses, one skilled in the art would understand that one or more of the sending devices 102-106 may be configured with permanent or static IP addresses, and as such, do not require a dynamic IP address. In one implementation, a spammer logs onto one of the sending devices, such as sending device 102, activates an email application on the sending device 102, and composes an email message comprising spam content in known manner to be delivered to one or more recipient devices 112, 114, and 116, such as recipient device 112. Recipient devices may comprise the functionality of one or more of the sending devices 102-106. In a destination subject line of the email message, the spammer enters one or more recipient addresses (or one or more are automatically entered), such as a domain address of john.smith@abc.com corresponding to recipient device 112.

Responsive to spammer input requesting delivery of the composed email message, the client server 108 assigns a dynamic IP address to the sending device 102 and the sending device 102 and the client server 108 establish a SMTP connection. The dynamic IP address is either randomly generated or allocated according to a predetermined policy as dictated by the ISP or other entity associated with the client server 108. Assignment of the dynamic IP address to the sending device 102 may be implemented according to well-known DHCP mechanisms, among others mechanisms (e.g., proprietary, etc.). For instance, according to DHCP implementations, a renewable lease time is granted to a requesting client device (i.e., a sending device 102-106 requesting the dynamic IP address), which allows the assigned dynamic IP address to be reclaimed by another sending device if the requesting device goes off-line.

The processing network 100 may also comprise a domain name system (DNS) 118 coupled to the WAN 110. The DNS 118 may be used to translate domain names to IP addresses. For instance, the client server 108 may obtain the IP address of the recipient device 112 from the DNS 118 corresponding to the domain address of john.smith@abc.com entered in a destination subject line of the email message.

The WAN 110 enables passage of IP packets corresponding to an email message and/or connection request, for instance according to TCP/IP, from the client server 108 to the spam control system 200. In one embodiment, the spam control system 200 comprises one or more server devices (e.g., mainframe, personal computer, gateway, etc.) that also include(s) one or more data repositories 220. The spam control system 200 further comprises email and spam control logic (e.g., modules of code), as described further below, that receives and forwards email messages, filters spam content and/or spam IP addresses, and maintains and/or manages one or more lists of static and dynamic IP addresses stored in the data repository 220. For instance, the spam control system 200 comprises functionality that determines whether an IP address identified as a source of spam, as evidenced by its listing in a blacklist (or other spam control lists or data structures used to block IP address or the corresponding email messages), has been re-assigned (relinquished by the spammer by going off-line or otherwise and reclaimed) such that the same IP address (e.g., a dynamic IP address) is no longer a source of spam. In addition to storing IP addresses, the data repository 220 may also store email messages, sent from the authorized sending devices 102-106, that can be accessed by the recipient devices 112-116 through well-known post-office protocols (POP) or other protocols. In some embodiments, the storage of IP addresses and email messages may be implemented through the use of separate data repositories.

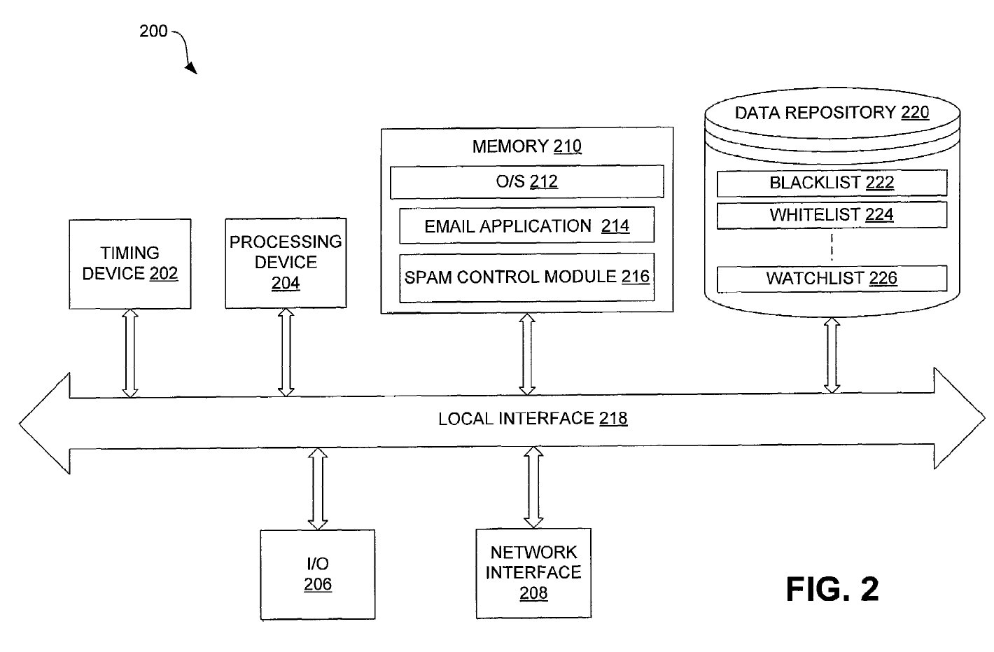

FIG. 2 is a block diagram of an embodiment of the spam control system 200. Though shown as a server device, in some embodiments, functionality of the spam control system 200 may be distributed among a plurality of devices, such as over a network. Generally, in terms of hardware architecture, the spam control system 200 includes a timing device 202, processing device 204, input/output (I/O) devices 206, network interface 208, memory 210, and data repository 220, each of which is communicatively coupled via a local interface 218. The local interface 218 can be, for example but not limited to, one or more buses or other wired or wireless connections, as is known in the art. The local interface 218 may have additional elements, which are omitted for simplicity, such as controllers, buffers (caches), drivers, repeaters, and receivers, to enable communications. Further, the local interface 218 may include address, control, and/or data connections to enable appropriate communications among the aforementioned components.

The processing device 204 is a hardware device for executing software, particularly that which is stored in memory 210. The processing device 204 can be any custom made or commercially available processor, a central processing unit (CPU), an auxiliary processor among several processors associated with the spam control system 200, a semiconductor-based microprocessor (in the form of a microchip or chip set), a macroprocessor, or generally any device for executing software instructions.

The memory 210 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 210 may incorporate electronic, magnetic, optical, and/or other types of storage media. Note that the memory 210 can have a distributed architecture, where various components are situated remotely from one another, but can be accessed by the processing device 204.

The software in memory 210 may include one or more separate programs, each of which comprises an ordered listing of executable instructions for implementing logical functions. In the embodiment shown in FIG. 2, the software in the memory 210 includes a suitable operating system (O/S) 212, an email application 214, and a spam control module 216. The operating system 212 essentially controls the execution of other computer programs, such as the email application 214 and the spam control module 216, and provides scheduling, input-output control, file and data management, memory management, and communication control and related services. Although shown as a module separate from the email application 214, in some embodiments, the spam control module 216 may be implemented as a module located within the email application 214.

In some embodiments, functionality of the email application 214 and/or spam control module 216 may be implemented using a single module, or distributed among a plurality of modules. For instance, in one embodiment, the spam control module 216 may comprise a kernel space module configured for performing IP address-based filtering at a TCP/IP network level (e.g., a network level using an open systems interconnection (OSI) model, compared to detection at a higher level such as an application level filter, for instance a mail transfer agent) and a user-space module configured for performing content-based filtering. Further, in some embodiments, IP address and content-based filtering functionality may be performed using one or more modules performed entirely in kernel space or entirely in user-space, among other configurations. The email application 214 comprises functionality to receive and forward email messages to the data repository 220 and/or recipient devices 112-116 based on spam filtering performed by the spam control module 216.

The spam control module 216 comprises spam filtering functionality, including IP address and/or content-based filtering, as explained above. In implementing address-based filtering, the spam control module 216, in one embodiment, determines whether an attempt by the client server 108 to establish a TCP/IP connection (e.g., a connection request) is derived from a source of spam that has an IP address already listed in a spam control list or lists in the data repository 220. The spam control module 216 may obtain the IP address using DNS query mechanisms, and/or inspecting a TCP header of a connection request or email message. As explained below, the data repository 220 comprises a data structure referred to herein as a blacklist 222 that lists IP addresses corresponding to one or more spammers. Such a list may be manually populated (e.g., by a network administrator), or populated through the use of various filtering mechanisms implemented by the spam control module 216, among other mechanisms. A connection request from the client server 108 that includes an IP address listed on the blacklist 222 is reset, or in some embodiments, the connection request is granted and the email message blocked. In some embodiments, denial (e.g., reset or blocked) of the connection request may be made based on the presence of the IP address of the connection request on a blacklist or other spam control list of another server device (e.g., which is communicated to the spam control module 216).

In other instances, the connection request may be granted (and thus packets corresponding to the email message allowed to pass) by the spam control module 216 on the basis of the existence of the IP address in a list of acceptable and/or authorized IP addresses (e.g., a whitelist 224, as explained below).

In some implementations, a connection request from an IP address that is not listed in the blacklist 222 and not listed on the whitelist 226 may still be granted by the spam control module 216 if the e-mail traffic of the source IP address does not exceed an e-mail traffic threshold monitored by the spam control module 216, subject to spam control such as content-based filtering of the spam control module 216 as a second tier of protection. In implementing content-based filtering, the email message may be passed to the data repository 220 for access by one of the recipient devices 112-116, or blocked based on the email message body comprising spam content (e.g., inappropriate content, marketing phrases or keywords, etc.). When blocked, the corresponding IP address is entered into the blacklist 222 by the spam control module 216. Thus, and as explained further below, the spam control module 216 comprises functionality to populate the various data structures (e.g., blacklist 222, whitelist 224, etc.) of the data repository 220 with IP addresses corresponding to a plurality of different sending devices (e.g., sending devices 102-106) based on various criteria, as well as functionality to manage the storage and disposition of these addresses.

The email application 214 and the spam control module 216 are source programs, executable program (object code), script, or any other entity comprising a set of instructions to be performed. The email application 214 and the spam control module 216 can be implemented, in one embodiment, as a distributed network of modules, where one or more of the modules can be accessed by one or more applications or programs or components thereof. When a source program, then the program is translated via a compiler, assembler, interpreter, or the like, which may or may not be included within the memory 210, so as to operate properly in connection with the O/S 212.

The network interface 208 includes devices that communicate both inputs and outputs, for instance but not limited to, a modulator/demodulator (modem for accessing another device, system, or network), a radio frequency (RF) or other transceiver, a telephonic interface, a bridge, a router, etc.

The I/O devices 206 may include input devices, for example but not limited to, a keyboard, mouse, scanner, microphone, etc. Furthermore, the I/O devices 206 may also include output devices, for example but not limited to, a printer, display, etc.

The data repository 220 comprises storage for email messages and/or IP addresses. Although one data repository 220 is shown, in some embodiments, a plurality of data repositories may be implemented. The IP addresses are entered in various data structures of the data repository 220 by the spam control module 216 in response to the implementation of various filtering mechanisms. In one embodiment, the data repository 220 comprises one or more data structures that include a blacklist 222, a whitelist 224, and a watchlist 226. The blacklist 222 comprises a data structure (e.g., database of records) that lists blocked IP addresses received and/or provided by the spam control system 200. The spam control module 216 monitors the activity of an IP address, newly entered in the blacklist 222 by the spam control module 216 or otherwise, during a predetermined period of time, compared to existing (e.g., already in the blacklist 222, for instance, as blocked static IP addresses entered by a network administrator) IP addresses recognized as known spamming addresses for which activity during a predetermined time period is not monitored. Based on monitoring the activity of the newly entered IP address, the spam control module 216 can determine whether the IP address continues to be a source of spam. In one embodiment, a time stamp is entered (e.g., recorded) along with the newly entered IP address, for instance in a data record comprising the newly entered IP address in one field and the time stamp in another field, which enables the spam control module 216, in cooperation with the timing device 202 and processing device 204, to keep track of (e.g., monitor a count or determine or calculate based on time differences) how long the IP address listed in the blacklist remains inactive.

In some embodiments, the time stamp may be recorded elsewhere (e.g., memory 210) and used as a basis by the spam control module 216 to track the time elapsed between entry in the blacklist 222 and any detected activity or time elapsed between entry in the blacklist 222 and the time corresponding to the end of the predetermined period. The time stamp may be generated by the timing device 202 and entered in the blacklist 222 by the processing device 204 under the direction of the spam control module 216. In some embodiments, the timing device 202 may be embodied as a counter that may be activated and recorded with the newly entered IP address (or recorded elsewhere and associated with the newly entered IP address, such as through pointers) upon entry of the IP address in the blacklist 222.

While there is continued activity (e.g., connection requests from the newly entered IP address) within a predetermined period of time (e.g., beginning from the recorded time stamp), the spam control module 216 infers from this activity that the IP address continues to be a spam source. In one embodiment, each instance of activity within the predetermined period of time causes a new time stamp to be recorded in the data structure of the same IP address, and the time period is reset and the new time period is monitored. If the spam control module 216 detects no activity after a predetermined time period, the spam control module 216 infers that the IP address is less likely to be a spam source and thus may have been relinquished by the spammer (e.g., a re-assigned dynamic IP address). Thus, responsive to the detection or determination by the spam control module 216 of inactivity up to (or beyond in some embodiments) a predetermined period of time, the spam control module 216 removes the IP address from the blacklist 222 and lists the same in the watchlist 226, along with a time stamp derived from the timing device 202. Such a process of removal from the blacklist 222 and entry into the watchlist 226 may be implemented according to several mechanisms, such as a copy and delete (e.g., delete or make writeable) operation or a move operation. Although described in the context of an IP address blacklist, other variations included within the scope of the term “blacklists” include without limitation DNS blacklists (i.e., a list of IP addresses corresponding to unwanted domains) and spam blacklists (i.e., lists of mail servers or open relays known to be used by spammers).

The whitelist 224 comprises a data structure that lists recognized and approved or trusted IP addresses received by the spam control module 216. An IP address is listed on the whitelist 224 as a result of various spam filtering mechanisms or through manual entry, and hence in one embodiment, is not subject to spam control.

The watchlist 226 comprises a data structure that lists dynamic and/or potential dynamic IP addresses that are removed from the blacklist 222 by the spam control module 216 based on exhibiting no activity during a predetermined period of time while on the blacklist 222. The IP addresses that are listed in the watchlist 226 are under a probationary period whereby the spam control module 216 continues to monitor the activity of that IP address for spamming activity before either inferring that the IP address has been re-assigned to a new source, thus allowing packets from the IP address to pass to recipient devices subject to filter controls as is regular email, or return the IP address to the blacklist 222 and designate the returned IP address as a source of spam.

In one embodiment, such monitoring while the IP address is in the watchlist 226 may comprise allowing a predetermined amount of packets to pass to recipient devices, an amount beyond which the spam control module 216 determines that the IP address is still associated with the spam source. If the spam control module 216 detects that the email traffic (e.g., packets) does not exceed a predetermined amount within a given time period, the IP address is removed from the watchlist 226, with the inference that the IP address has been re-assigned to a new source and is hence subsequently subject to standard filter controls as is most email.

In some embodiments, the event of returning the IP address back to the blacklist 222 may be signaled to other devices or entities. For instance, responsive to the re-entry of the IP address into the blacklist 222, the spam control module 216 may log a message to indicate that recurring spam activity has been detected for this entered IP address. Such a message may be used by an administrator to decide whether he or she wishes to designate (e.g., via a spam control configuration utility) the IP address as a static/permanent IP source.

As explained above, responsive to determining that there is no activity by the IP address in the blacklist 222 up to or beyond a predetermined period of time, the spam control module 216 removes the IP address from the blacklist 222 and enters the same (or a copy of the same) in the watchlist 226, along with a time stamp derived from the timing device 202, the time stamp corresponding to the time that the IP address is entered into the watchlist 226. In somewhat similar manner to the methodology (e.g., time stamps, time monitoring) described above in monitoring the activity of the IP address while on the blacklist 222, the absence of spamming activity for the same IP address (e.g., an amount of packets received by the spam control module less than or equal to a predetermined threshold amount) during a predetermined time period while in the watchlist 226 prompts the removal by the spam control module 216 of the IP address (determined to be a dynamic IP address that has been re-assigned) from the watchlist 226. If spamming activity for the IP address while in the watchlist 226 is detected by the spam control module 216 within a predetermined period of time, the IP address in the watchlist 226 is returned to the blacklist 226.

Although the data repository 220 is described as comprising one or more blacklists 222, whitelists 224, and watchlists 226, in some embodiments, other (or fewer or more) data structures may be employed in the data repository 220, including gray lists, etc. Additionally, in some embodiments, the above described data structures may be implemented as one list with suitable flags or indicators in various record fields specific to the type of designation (e.g., blocked, probation, allowed, etc.). In some embodiments, the one or more lists may be replaced with state information comprising the type of designation.

When the spam control system 200 is in operation, the processing device 204 is configured to execute software stored within the memory 210, to communicate data to and from the memory 210, and to generally control operations of the spam control system 200 pursuant to the software. The email application 214, the spam control module 216, and the O/S 212, in whole or in part, but typically the latter, are read by the processing device 204, perhaps buffered within the processing device 204, and then executed.

When the email application 214 and/or the spam control module 216 are implemented in software, as is shown in FIG. 2, it should be noted that the email application 214 and/or the spam control module 216 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The email application 214 and/or the spam control module 216 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

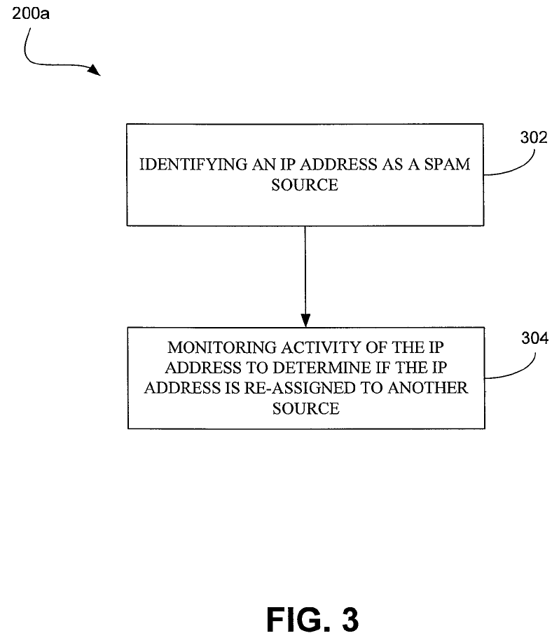

In view of the above description of the various embodiments of the spam control system 200, it would be appreciated that one embodiment of a spam control method 200a, as shown in FIG. 3, comprises identifying an IP address as a spam source (302) and, monitoring activity of the IP address to determine if the IP address is re-assigned as another source (304). Such identification may be implemented through the entry of the IP address into the blacklist 222.

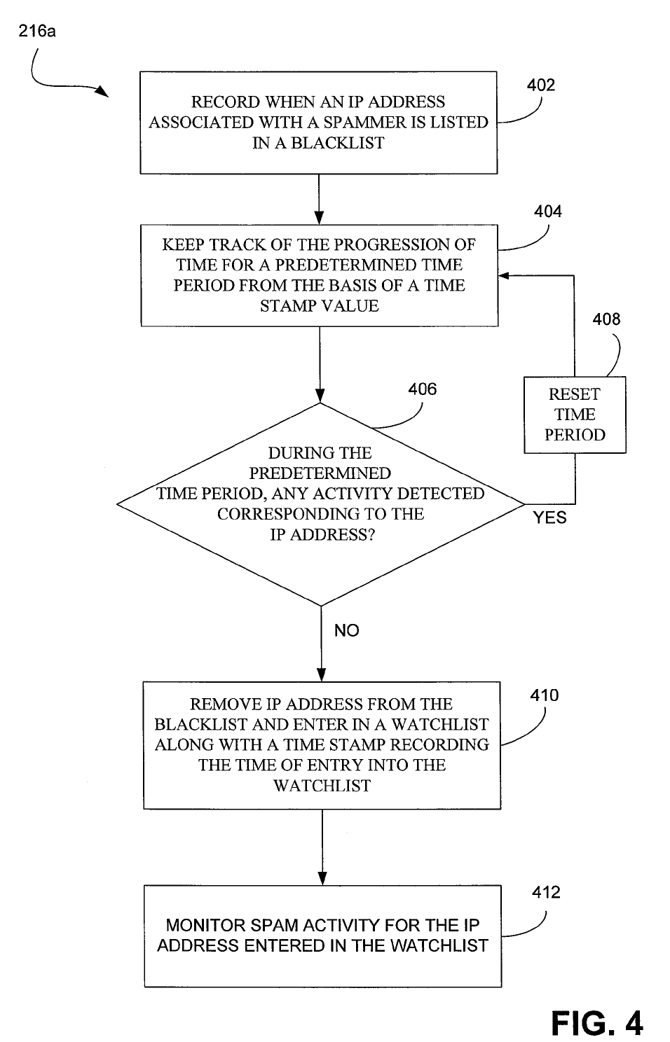

It would also be appreciated, in view of the above description, that one embodiment of a spam control method 216a, shown in FIG. 4 and implemented by the spam control module 216 of the spam control system 200, comprises recording when an IP address associated with a spammer is listed in the blacklist 222 (402). As explained above, such a recording may be implemented through storage (e.g., in a data record field associated with the data record of the IP address) of a time stamp derived from the timing device 202, or in some embodiments, derived from a time stamp embedded in the IP packet pertaining to a connection request by the IP address. The spam control module 216, in cooperation with the processing device 204 and timing device 202, keeps track of the progression of time for a predetermined period of time from the basis of the time stamp value (404). During the period between the time stamp value and a time or count value corresponding to the end of the time period, the spam control module 216 determines whether any activity corresponding to the IP address is detected (406). Such activity may include, for example, connection requests pertaining to any email messages delivered from the IP address.

If the spam control module 216 detects activity during this predetermined period, then the timing period is reset (408). For instance, a new time stamp may be entered in the corresponding record of the IP address in the blacklist 222, and activity is monitored during the predetermined period based from the new time stamp value. One skilled in the art would understand that other mechanisms may be employed for timing the period, including using the same time stamp value and simply tacking on a second period of time equivalent to the first, or resetting a counter, etc. If the spam control module 216 detects no activity during this predetermined period, then the IP address, considered now to potentially be a dynamic IP address that has been re-assigned to a non-spam source (or at least a new source), is removed from the blacklist 222 and entered into the watchlist 226 along with a time stamp recording the time of entry into the watchlist 226 (410). Once entered into the watchlist 226, monitoring for spam activity can commence (412), as explained further below.

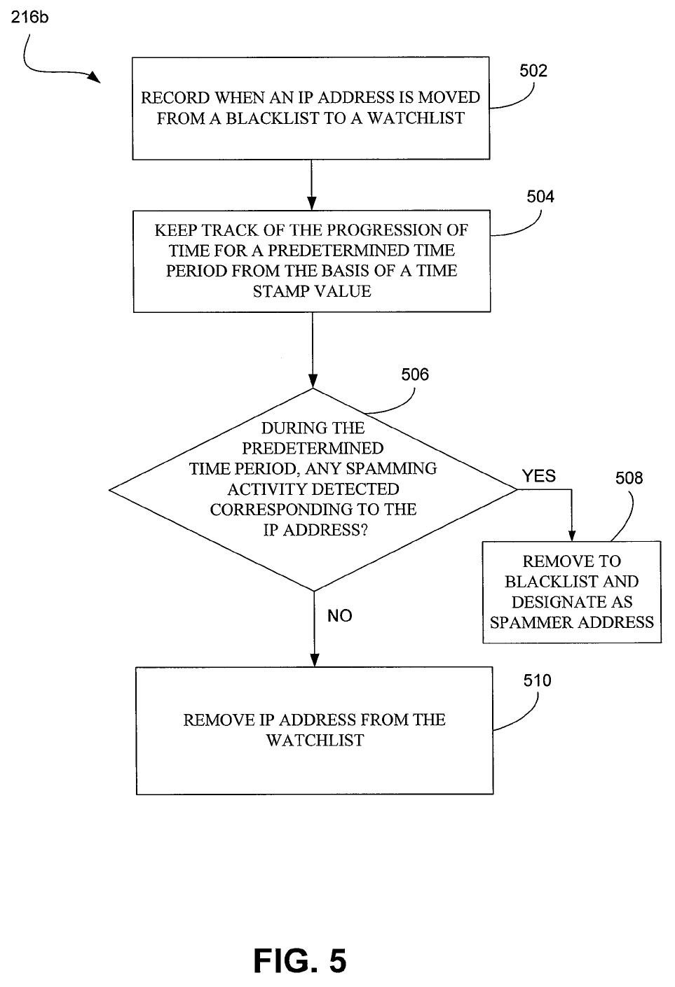

As illustrated in 412 of FIG. 4, the spam control method 216b monitors for activity of an IP address moved from the blacklist 222 to the watchlist 226. An embodiment of a spam control method 216b (as implemented by the spam control module 216 of the spam control system 200) that implements this spam monitoring is illustrated in FIG. 5. The spam control module 216 records when the IP address is moved from the blacklist 222 to the watchlist 226 (502). Such a recording may be of a time stamp derived from the timing device 202 or IP packet, as explained above. The spam control module 216, in cooperation with the processing device 204 and timing device 202, keeps track of the progression of time for a predetermined period of time from the basis of the time stamp value (504). During the time period between the time stamp value and a time or count value corresponding to the end of the predetermined time period, the spam control module 216 determines whether any spamming activity corresponding to the IP address is detected (506). In other words, in some embodiments, a certain level of packets is allowed to pass as long as the level does not rise to a threshold signifying spam activity. Spamming activity may be evidenced by the detection of connection requests and/or email traffic volume that exceed a predetermined threshold, and/or by the presence of spam content. Thus, the spam control module 216 may detect such activity through IP address-based filtering and/or content-based filtering (the latter employed locally or remotely), including excessive connection requests, excessive packet counts, profane language, prices for products, and/or key words or phrases associated with attempts to sell products pertaining to any email messages emanating from the IP address, and/or manual entry or communication from other devices.

If the spam control module 216 detects spamming activity during this predetermined period of time, then the IP address is returned to the blacklist 222 and designated as an IP address associated with a spammer (508). In some embodiments, the IP address may be added into the blacklist 222 and considered a “new entry” for purposes of re-commencing the monitoring of spam activity according to the disclosed embodiments. In some embodiments, the IP address may be designated (e.g., automatically or manually by a network administrator, such as based on a log message as described above) as a permanent/static IP address associated with a spammer, and continued monitoring of spam activity by the spam control module 216 for the newly designated IP address is terminated and all corresponding e-mail traffic for the permanent/static IP address as newly designated is blocked. If the spam control module 216 detects no spamming activity during this predetermined period of time, then the IP address, considered to be a dynamic IP address that has been re-assigned to a non-spam source or otherwise a new source, is removed from the watchlist 226 (510), enabling the passage of IP packets from this dynamic IP address subject to filter controls.

The flow diagrams of FIGS. 3-5 show the architecture, functionality, and operation of possible implementations of the spam control module 216 software. In this regard, each block represents a module, segment, or portion of code, which comprises one or more executable instructions for implementing the specified logical function(s). It should also be noted that in some alternative implementations, the functions noted in the blocks may occur out of the order noted in FIGS. 3-5. For example, two blocks shown in succession in FIG. 5 may in fact be executed substantially concurrently or the blocks may sometimes be executed in the reverse order, depending upon the functionality involved.

It should be emphasized that the above-described embodiments are merely possible examples of implementations, merely set forth for a clear understanding of the principles of the spam control systems (and methods) 200. Many variations and modifications may be made to the above-described embodiment(s). All such modifications and variations are intended to be included herein within the scope of this disclosure.

What is claimed:

1. A spam control method, comprising:
identifying an IP address as a spam source; and
monitoring activity of the IP address to determine if the IP address is re-assigned to another source.

2. The method of claim 1, wherein identifying further comprises entering the IP address in a first list of IP addresses corresponding to spam sources, wherein packets associated with the IP address are disallowed from passing to recipient devices while the IP address is in the first list.

3. The method of claim 2, further comprising removing the IP address from the first list and entering the IP address into a second list responsive to determining that no activity for the IP address is detected during a first predetermined time period, the second list configured to store IP addresses that are moved from the first list and that are each monitored for a second predetermined time period.

4. The method of claim 3, further comprising monitoring the IP address during the second predetermined time period to determine if spamming activity is detected in association with the IP address during the second predetermined time period.

5. The method of claim 4, further comprising removing the IP address from the second list and returning the IP address to the first list responsive to determining that spamming activity is detected in association with the IP address during the second predetermined time period.

6. The method of claim 5, further comprising logging a message that indicates that the IP address returned to the first list is associated with a spam source.

7. The method of claim 4, further comprising removing the IP address from the second list and allowing passage of packets corresponding to the removed IP address to an email recipient downstream of a device in which the spam control method is implemented responsive to determining that no spamming activity corresponding to the IP address is detected during the second predetermined time period.

8. The method of claim 3, further comprising restarting the first predetermined time period responsive to detecting activity of the IP address during the first predetermined time period.

9. The method of claim 1, wherein monitoring further comprises determining whether a connection request from the IP address occurs during a first predetermined time period.

10. The method of claim 9, wherein monitoring further comprises tracking the progression of time from a first time reference to a second time reference, the difference in time between the first time reference and the second time reference comprising the first predetermined time period.

11. A spam control system, comprising:
a memory with logic; and
a processor configured with the logic to monitor activity of an IP address associated with a spam source and responsive to the monitoring, determine if the IP address is re-assigned to another source.

12. The system of claim 11, wherein the processor is further configured with the logic to store the IP address in a first list, the first list comprising one or more data structures of static and dynamic IP addresses, the static and dynamic IP addresses associated with packets that are blocked from passing to email recipients downstream of the spam control system.

13. The system of claim 12, wherein the processor is further configured with the logic to remove the IP address from the first list and store the IP address into a second list responsive to determining that no activity for the IP address is detected during a first predetermined time period, the second list configured to store IP addresses that are moved from the first list and that are each monitored for a second predetermined time period.

14. The system of claim 13, wherein the processor is further configured with the logic to monitor the IP address during the second predetermined time period to determine if spamming activity is detected in association with the IP address during the second predetermined time period.

15. The system of claim 14, wherein the processor is further configured with the logic to remove the IP address from the second list and return the IP address to the first list responsive to determining that spamming activity is detected in association with the IP during the second predetermined time period.

16. The system of claim 15, wherein the processor is further configured with the logic to log a message that indicates that the IP address returned to the first list is associated with a spam source.

17. The system of claim 14, wherein the processor is further configured with the logic to remove the IP address from the second list and allow the passage of packets corresponding to the IP address to email recipients responsive to determining that no spamming activity corresponding to the IP address is detected during the second predetermined time period.

18. The system of claim 13, wherein the processor is further configured with the logic to restart the first predetermined time period responsive to detecting activity of the IP address during the first predetermined time period.

19. The system of claim 11, wherein the processor is further configured with the logic to determine whether a connection request from the IP address occurs during a first predetermined time period.

20. The system of claim 19, wherein the processor is further configured with the logic to track the progression of time from a first time reference to a second time reference, the difference in time between the first time reference and the second time reference comprising the first predetermined time period.

21. A spam control system, comprising:
means for monitoring activity of an IP address associated with a spam source; and
means for determining whether the IP address has been re-assigned to another source.

22. The system of claim 21, wherein the means for monitoring comprises means for monitoring during a first predetermined time period.

23. The system of claim 22, wherein the means for monitoring comprises means for monitoring during a second predetermined time period responsive to detecting no activity associated with the IP address during the first predetermined time period.

24. The system of claim 23, wherein the means for determining comprises means for inferring from the absence of spam activity during the second predetermined time period that the IP address has been re-assigned to the another source.

25. A computer-readable storage medium having computer-executable functions for implementing spam control, comprising:
logic configured to identify an IP address as a spam source; and
logic configured to monitor activity of the IP address to determine if the IP address is re-assigned to another source.
